(19) United States
(12) Patent Application Publication
(10) Pub. No.: US 2018/0368435 A1
(43) Pub. Date: Dec. 27, 2018

(54) DEVICE FOR PRODUCING CONSUMABLE PRODUCTS

(71) Applicant: KMB PRODUKTIONS AG, Felben (CH)

(72) Inventor: Guido Knobel, Kreuzlingen (CH)

(73) Assignee: KMB PRODUKTIONS AG, Felben (CH)

(21) Appl. No.: 15/774,717

(22) PCT Filed: Nov. 10, 2016
(86) PCT No.: PCT/EP2016/077292

§ 371 Date: May 9, 2018

(30) Foreign Application Priority Data
Nov. 11, 2015 (DE) 10 2015 119 438.4

(51) Int. Cl. A23G 1/21; A23G 1/00; A23G 1/22; A23P 30/10

(52) U.S. Cl. CPC A23G 1/21; A23G 1/0086; A23P 30/10; A23G 1/226; A23G 1/0076

(57) ABSTRACT

A device for manufacturing food products having an outer shell made of a flowable mixture, which is filled into a mould, wherein a temperature-controlled die (2) is immersed in the mould and extrudes the mixture wherein the mould into which the flowable mixture is filled is a blister (3), wherein the blister (3) is held by a carrier mould (4), wherein the carrier mould (4) has an intake duct (6) for air and has longitudinal vacuum channels (7) and/or transverse vacuum channels (8) between cavities (5).

### BACKGROUND OF THE INVENTION

The invention relates to a device for manufacturing food products having an outer shell made of a flowable mixture, which is filled into a mould, wherein a temperature-controlled die is immersed in the mould and extrudes the mixture.

Such devices for manufacturing food products are known in a variety of forms and embodiments.

In a number of food products, it is necessary to manufacture an outer shell of a flowable mixture, wherein said flowable mixture is pressed into a mould and set there by appropriate temperature control, thus assuming a solid shape.

This applies, for example, to chocolate pralines. For these, an outer shell or outer shells are needed, into which a food mixture is filled where required. The praline is later closed by a further shell or similar.

For this purpose, heated, flowable chocolate is poured into a mould and moulded into a shell-like shape by a compression die, wherein the die is cooled and sets the chocolate mixture to the shell during the moulding process.

This is described in W0001998052425A1. In addition to this, in this invention, attention must be paid to the temperature-controlled die, which causes the die to be easily removable from the chocolate mould.

However, there is a disadvantage with these inventions. The chocolate is always poured into solid moulds and must then be removed from these moulds once more.

This is uneconomical and awkward in terms of handling.

### SUMMARY OF THE INVENTION

The object of the present invention is now to find a more economical and simple solution in terms of handling.

To solve this object, the mould into which the flowable mixture is filled is a blister.

The blister of the present invention is a mould that is mostly made of plastic and has multiple cavities. It can be compared with an ice cube tray. The filling of the flowable mixture, which in the preferred exemplary embodiment consists of chocolate, and the moulding of the same in the blister have the great advantage that the chocolate moulds can also be sold in this blister as a semi-finished product. The complicated filling is simply replaced here, meaning a significant time saving.

The blister is again positioned in a carrier mould so that it is in a stable position and does not sag or rupture when the die(s) are immersed. It can then be easily removed from this carrier mould and sold at the end of manufacture. Easy handling is guaranteed.

A temperature-controlled die, as described by W0001998052425A1, is immersed in the flowable mixture in the blister. This means that the die can be very easily pulled out of the flowable mixture once more without sticking.

Furthermore, the food mixture partially sets in the blister and forms at least one shell shape. Everything takes place in the blister, which carries the further advantage of cleanliness and hygiene.

The carrier mould, in which the blister is positioned, has an intake duct for air and further transverse and longitudinal vacuum channels cross the cavities of the carrier mould. As a result of this, the blister is suctioned onto the carrier mould so that it is firmly positioned during production and cannot slip. This has the great advantage that the chocolate moulds that are produced in this process have a precise shape without unwanted deformations.

The vacuum is also held upright until the die exits the mould again. This means that the blister cannot be pulled upwards with the die while it exits the blister.

### DESCRIPTION OF FIGURES

Further advantages, features and details of the invention will arise from the following description of preferred exemplary embodiments and from the drawing; this shows in

FIG. 1 is a perspective view of a device according to the invention for the manufacture of food products;

FIG. 2 is a perspective view of a carrier mould with an inserted blister;

FIG. 3 shows a cross section through the carrier mould with an inserted blister according to FIG. 2;

FIG. 4 is an enlarged perspective detail view of the carrier mould;

FIG. 5 is a perspective view of the carrier-mould with intake duct;

FIG. 6 shows a cross section of the carrier mould without blister in the region of a vacuum channel;

FIG. 7 shows a cross section of the carrier mould without blister in the region of the intake duct.

### DETAILED DESCRIPTION

From a device V for manufacturing food products, in particular chocolate shells, a cold compression head 1 with dies 2 located thereon, a blister 3 and a carrier mould 4 are shown in FIG. 1. The cold compression head 1 with the dies 2 is known from previous inventions of the applicant. For example, the die 2 is described in WO 1998052425 A1 as a temperature controlled die. Furthermore, it is claimed there that the dew point of the atmosphere surrounding the food product is kept below the temperature of the die, which has the effect that the die 2 does not form any ice crystals on its tip, which in turn means that no water stains form on the food product and the die can be easily removed from a moulded chocolate shell.

Another feature of the die 2 is described in WO 2003094626 A1. It has a die surface, to which a bevel adjoins an edge of the mould. This causes the mixture of excess food to be pressed over the edge of the mould, and at the same time to also be separated from the shell shape, so that the excess edge can then be very easily separated from the shell shape with a scraper or knife.

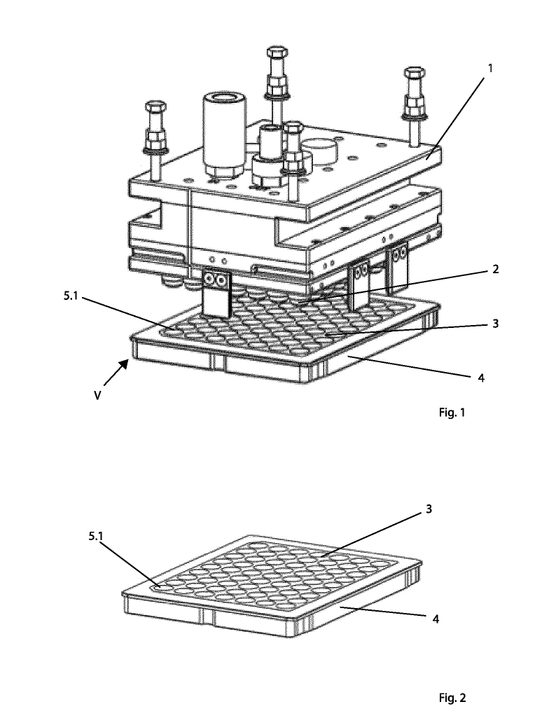

According to FIGS. 1 and 2, the blister 3 forms a plurality of cavities 5.1 into which the food product flows. In the preferred exemplary embodiment it is detachably connected with the carrier mould 4. The carrier mould 4 also has cavities 5.2, which are clearly shown in FIG. 4.

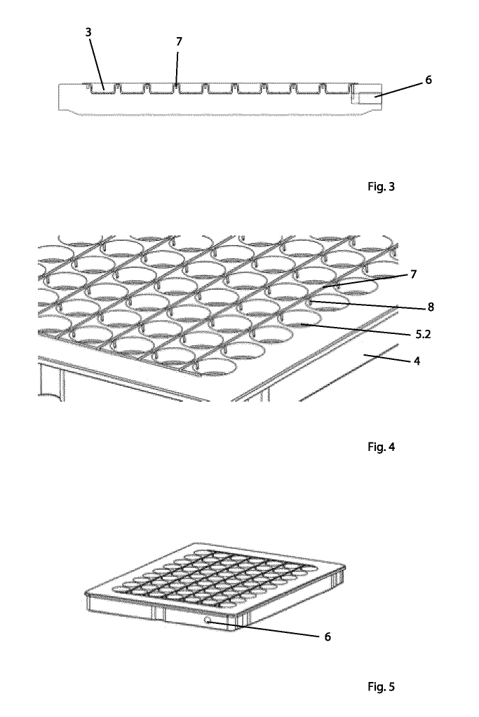

FIG. 3 shows a cross section of the carrier mould 4 together with blister 3. Here, longitudinally extending vacuum channels 7 can be seen. The associated intake duct 6 sucks air from the vacuum channels 7 just before immersion of the die 2, which causes the blister 2 to remain in position in its carrier mould 4 until the dies 2 are pulled back out of the blister 2 and the moulded chocolate shells.

In FIG. 4, the carrier mould 4 is shown without blister 3. Clearly visible here are not only the longitudinally extending vacuum channels 7, but also the transverse vacuum channels 8, which are arranged transversely to the cavities 5.2 of the carrier mould 4. The air from the transverse vacuum channels 8 is also exhausted via the intake duct 6.

The intake duct 6 and its opening are clearly shown again in FIG. 5 in a perspective view.

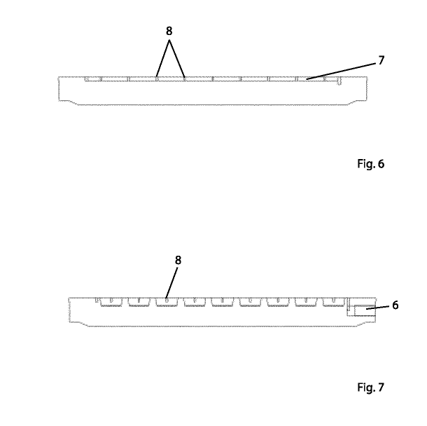

Likewise, FIGS. 6 and 7 once again illustrate the longitudinal and transverse vacuum channels 7 and 8 and their position in the carrier mould 4.

The invention works as follows:

The liquid food mixture, for example liquid chocolate, is poured directly into the blister 3, which is positioned in a carrier mould 4 which stabilises it. The carrier mould 4 is designed so that it has an intake duct 6 on the rear side of the mould and has both transverse and longitudinal vacuum channels 7 and 8 between the cavities. Through these vacuum channels 7 and 8, a vacuum is generated, which pulls the blister 3 downwards, shortly before the immersion of the die 2. The suction effect through the vacuum continues until the dies 2 once again exit at least one part of the food product after cooling.

In the blister 3, the food product is now available in at least one shell shape. Any excess food product is removed with a knife or scraper from the edge of the blister 3.

The blister 3 can now be removed and subjected to further processing, or sold as a semi-finished product.

List of Reference Numerals

| | |
|---|---|
| 1 | Cold compression head |
| 2 | Die |
| 3 | Blister |
| 4 | Carrier mould |
| 5 | Cavity |
| 6 | Intake duct |
| 7 | Vacuum channel |
| | longitudinal |
| 8 | Vacuum channel |
| | transverse |
| 9 | |
| 10 | |
| 11 | |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |

1-10. (canceled)

11. Device for manufacturing food products having an outer shell made of a flowable mixture, which is filled into a mould, wherein a temperature-controlled die (2) is immersed in the mould and extrudes the mixture, wherein the mould into which the flowable mixture is filled is a blister (3), wherein the blister (3) is held by a carrier mould (4), wherein the carrier mould (4) has an intake duct (6) for air and has longitudinal vacuum channels (7) and/or transverse vacuum channels (8) between cavities (5).

12. Device according to claim 11, wherein after filling the flowable mixture, a temperature-controlled die (2) is immersed.

13. Device according to claim 11, wherein the food mixture partially sets in the blister (3) by means of the temperature-controlled die (2), and at least one shell shape forms.

14. Device according to claim 12, wherein the food mixture partially sets in the blister (3) by means of the temperature-controlled die (2), and at least one shell shape forms.

15. Method for manufacturing food products with an outer shell from a flowable mixture which is filled into a mould, wherein a temperature-controlled die (2) is immersed in the mould and extrudes the mixture, wherein the flowable mixture is filled into a blister (3), which is held in a carrier mould (4), wherein a vacuum is generated between the carrier form (4) and the blister (3) shortly before the immersion of the die (2) and is held upright at least until the die (2) exits the mould again.
